(19) United States
(12) Patent Application Publication
(10) Pub. No.: US 2026/0034557 A1
(43) Pub. Date: Feb. 5, 2026

(54) APPLICATOR ASSEMBLY AND NOZZLE FOR APPLYING A FLOWABLE VISCOUS MATERIAL, AND METHOD OF USING THE APPLICATOR ASSEMBLY

(71) Applicant: Henkel AG & Co. KGaA, Duesseldorf (DE)

(72) Inventors: Oto Tot, Ladenburg (DE); Joern Senftleben, Dielheim (DE); YaLong Qi, Shanghai (CN); Chao Li, Shanghai (CN); Klaus Ziegler, Heddesheim (DE); ZheCheng Dong, Shanghai (CN); Serkan Aldemir, Duesseldorf (DE); Hiroyuki Nagao, Yokohama (JP); DeJin Pan, Shanghai (CN); Ting Jiang, Shanghai (CN)

(21) Appl. No.: 19/352,582

(22) Filed: Oct. 8, 2025

Related U.S. Application Data
(63) Continuation of application No. PCT/CN2023/088345, filed on Apr. 14, 2023.

(51) Int. Cl. B05C 5/02; B05B 1/04; B05C 17/12

(52) U.S. Cl. CPC B05C 5/0254; B05B 1/04; B05C 17/12

(57) ABSTRACT

A nozzle for an applicator by which a flowable viscous material suitable for forming a liquid applied sound deadener can be distributed, the nozzle comprising: a proximal end releasably coupled to the applicator and having an end side in which a single proximal opening is formed; a distal end opposing the proximal end and having an end side in which a single distal opening is formed; and an interior hollow chamber defined between the proximal end and the distal end and in fluid communication with both the proximal opening and the distal opening, the nozzle being configured such that when being distributed by the nozzle, the flowable viscous material can be supplied from the proximal end to the distal end and discharged out of the distal opening, and the distal opening has a straight edge and a sawtooth-shaped or sine-shaped or wave-shaped edge opposing the straight edge.

### FIELD

The present disclosure generally relates to a nozzle for application of a flowable viscous material, and to an applicator assembly and/or system equipped with the nozzle and a method of using the applicator assembly, in one embodiment the applicator is a hand-held tool capable of applying the flowable viscous material in a non-production line situation.

### BACKGROUND

Noise and/or vibration control is a very important factor in designing and manufacturing motor vehicles. Usually, for the purposes of noise (like structure-borne noise) and/or vibration reduction, a liquid applied sound deadener (LASD) is applied on car body structures or between two components of a motor vehicle, such a structural part of the motor vehicle and as a sound or vibration deadening sheet, so that after the sound or vibration deadening sheet is securely attached onto the structural part, the potential noise and/or vibration which might occur on the components or in between can be decreased. The LASD is comprised of a flowable damping sound insulation material which will be distributed in a liquid state by an applicator system provided with a nozzle. In manufacturing plants of the motor vehicles, special tools are equipped such that the LASD can be applied in a specified pattern, such as a multi-bead texture. Those special tools may comprise the applicator with the nozzle and other devices. They are configured to cooperate with each other to ensure that the LASD can be applied in the specified pattern.

After a motor vehicle leaves the factory, it may undergo inspection and/repairing. During repairing or inspecting the motor vehicle, a technician of a service shop may disassemble a structural part of the motor vehicle which has been applied with a LASD thereon. After the structural part has been inspected and/or repaired or even replaced by a new one, a new sound or vibration deadening sheet might be attached to the structural part again. In this case, the LASD will have to be applied again on and/or between them before the sheet is attached to the structural part. However, in the after-market, it is very difficult for the technician to apply the LASD faultlessly and strictly in the same specified pattern as the manufacturing plants do. This is because in the after-market it is too expensive and requires special conditions for the service shop to equip those special tools of the manufacturing plants. Sometimes, the technician will have to use a traditional nozzle which can apply a single bead of the LASD, to generate a texture, resembling the required multi-bead texture, by repeatedly applying several beads of the material adjacent to each other. However, this manual operation is less efficient and the applied texture is usually different than the required multi-bead texture to a greater extent because the applied texture will have beads which are not specially-shaped, routed or not equidistant from each other. This will significantly degrade the noise and/or vibration control. Besides, in the prior art, the technician may use a nozzle to apply a wider and flat strip of the LASD on a surface and then use a scraper to scrap the applied strip to generate a texture, resembling the required multi-bead texture. However, this manual operation has the same short-comings as mentioned above.

If the LASD cannot be applied faultlessly and strictly in the specified pattern, for example as in a multi-bead texture in which the beads of the material are specially-shaped, routed, and equidistant from each other, the noise and/or vibration control will become poor after the components of the motor vehicle are assembled.

Therefore, it is desirable to develop an apparatus or an applicator which can be manually and readily operated by a technician of a service shop to apply the LASD onto a surface in a multi-bead texture.

### SUMMARY

In order to solve the issues mentioned above, the present disclosure is aimed at proposing a novel nozzle which can be installed onto a cartridge of an applicator such that a flowable viscous material such as a LASD or flowable sealant can be applied through the nozzle in a specified pattern such as a multi-bead texture, especially in the after-market.

According to an aspect, the present disclosure proposes a nozzle for an applicator which is configured to apply a flowable viscous material, the nozzle comprising:
a proximal end releasably coupled to a cartridge of the applicator and having an end side in which a single proximal opening is formed;
a distal end opposing the proximal end and having an end side in which a single distal opening is formed; and
a hollow chamber defined in an interior of the nozzle between the proximal end and the distal end and in fluid communication with both the proximal opening and the distal opening,
wherein the nozzle is configured such that when being distributed by the nozzle, the flowable viscous material can be supplied from the proximal end to the distal end and discharged out of the distal opening, and the distal opening has a straight edge and a sawtooth-shaped or sine-shaped or wave-shaped edge opposing the straight edge.

In an embodiment, the applicator is configured as a hand-held tool capable of applying the flowable viscous material in a non-production line situation only.

In an embodiment, the flowable viscous material is a flowable damping insulation material or a flowable sealant.

Therefore, taking the flowable damping insulation material for example, the flowable damping sound insulation material can be distributed in a multi-bead texture through the nozzle. Unlike usage of special tools in the factory or a scraper in the prior art (like a production line situation), the multi-bead texture comprised of beads of the material can be distributed once directly by the nozzle and further the applied beads of the material can be uniformly shaped or routed. Therefore, it will be easy and cost-efficient for a technician in the non-production line situation to apply the LASD onto a surface, like a surface of a component of a motor vehicle in the after-market.

In an embodiment, the distal opening has a cross-sectional area less than that of the proximal opening.

The different cross-sectional areas of the distal and proximal openings will ensure that the flowable damping sound insulation material when being supplied through the nozzle can be sufficiently compressed and thus further pressurized.

In an embodiment, the nozzle is divided into a proximal segment in which the proximal end locates and a distal segment in which the distal end locates, the hollow chamber is substantially cylindrical in the proximal segment and becomes wider in the distal segment as the hollow chamber in the distal segment extends from a location, at a distance from the proximal end, to the end side where distal opening is formed, and observed along a thickness direction of the nozzle, the hollow chamber in the distal segment gradually tapers from the proximal segment to the location and then gradually expands from the location to the end side where the distal opening is formed.

Such a design of the hollow chamber can ensure that when the flowable damping sound insulation material flows through the hollow chamber, the material is prevented from being unexpectedly blocked and then it is beneficial that the material can be pressurized smoothly.

In an embodiment, the cross-sectional area of the hollow chamber reaches its minimum substantially at the location.

In an embodiment, the hollow chamber in the distal segment is configured to have two opposing inner walls between the location and the end side where the distal opening is formed.

In an embodiment, a first inner wall of the two opposing inner walls is substantially flat, a second inner wall of the two opposing inner walls is configured such that as it extends from the location to the end side where the distal opening is formed, the second inner wall departs outwards from the first inner wall.

In an embodiment, several ridges are formed in the second inner wall such that they protrude from the second inner wall towards the first inner wall, but are spaced from the first inner wall.

In an embodiment, at least some of the ridges have different lengths.

In an embodiment, the ridges are flush with each other at the end side of the distal end such that the sawtooth-shaped or sine-shaped or wave-shaped edge is defined by the ridges in the distal opening.

In an embodiment, the ridges are spaced from each other along a widthwise direction of the nozzle.

In an embodiment, each of the ridges is configured in such a way that as the respective ridge extends from a start point within the hollow chamber to the end side of the distal end, the cross-sectional area of the ridge itself becomes gradually greater and finally reaches its maximum at the end side of the distal end.

In an embodiment, the cross-section of the ridges is triangle-shaped with the triangle's vertex pointing towards the first inner wall.

In an embodiment, in case of the sawtooth-shaped edge, as each ridge extends from its start point within the hollow chamber to the end side of the distal end, the vertex of the triangle-shaped cross-sectional area of the ridge forms a vertex line.

In an embodiment, in case of the sine-shaped or wave-shaped edge, as the ridges extend from their respective start points within the hollow chamber to the end side of the distal end, the vertexes of crests of the sine or wave shape of the cross-sectional area of the ridges form vertex lines.

In an embodiment, vertex lines of the ridges are parallel to each other and spaced from each other in the widthwise direction by a first interval, and are spaced from the first inner wall in the thickness direction by a second interval less than the first interval.

In an embodiment, each ridge has two slopes which intersect with each other at the vertex line of the ridge.

In an embodiment, between two adjacent ridges, a channel is formed by two slopes of the adjacent ridges facing each other, and/or a channel is formed between a lateral sidewall of the hollow chamber and the outermost ridge of the ridges along the widthwise direction adjacent to the lateral side wall such that several channels are formed in the hollow chamber.

In an embodiment, the distal segment has two opposing outer surfaces on each of which is formed with a reinforcement rib configured to have a length extending along a longitudinal central axis of the nozzle.

According to another aspect, the present disclosure proposes an applicator assembly capable of applying a flowable damping insulation material, comprising:
a hand-held applicator including a cartridge for containing the flowable damping sound insulation material therein and an application dispenser operatively and releasably coupled to the cartridge; and
a nozzle as mentioned here, wherein the nozzle is configured such that it is releasably coupled to the cartridge, and the flowable damping sound insulation material can be selectively distributed through the nozzle by manual manipulation of the application dispenser.

In an embodiment, the applicator is configured as a hand-held tool capable of applying the flowable damping insulation material in a non-production line situation only.

In an embodiment, the application dispenser is a manually operative application dispenser.

According to another aspect, the present disclosure proposes an apparatus for applying a flowable viscous material onto a surface to be coated, the apparatus comprising:
a nozzle as mentioned here;
an applicator, the nozzle being releasably coupled to the applicator;
a pumping device configured to be in fluid communication with the applicator; and
a container for storing a flowable viscous material and configured to be in fluid communication with the pumping device.

In an embodiment, the apparatus further comprises a heater configured to selectively heat the flowable viscous material during or prior to application of the flowable viscous material through the nozzle.

In an embodiment, the flowable viscous material is a flowable damping insulation material or a flowable sealant.

In an embodiment, the surface to be coated is a surface of a component of a motor vehicle after the motor vehicle has been repaired or inspected.

According to another aspect, the present disclosure proposes a method of using an applicator assembly as mentioned here, comprising:
coupling a nozzle to a cartridge before the cartridge is installed into a hand-held applicator, in a non-production line situation only, wherein the cartridge is configured to contain a flowable damping sound insulation material therein; and
coupling the cartridge to an application dispenser of the applicator in the non-production line situation such that manual manipulation of the application dispenser enables the flowable damping sound insulation material to be selectively distributed through the nozzle to a surface to be coated at room temperature.

In an embodiment, during the distribution of the flowable damping sound insulation material, a sawtooth-shaped or sine-shaped or wave-shaped edge of a distal opening of the nozzle is placed to be closer to a surface to be coated than a straight edge of the distal opening.

In an embodiment, the pressure and/or the quantity of the flowable damping sound insulation material distributed through the nozzle is adjustable by the applicator.

Using the technical measures according to the present disclosure, it is easy and convenient for a technician of a service shop to, especially in the non-production line situation, apply the LASD onto a surface, such as a surface of a structural part of a motor vehicle, in a multi-bead texture so that a sound or vibration deadening sheet can be attached via the applied LASD to the surface and thus noise and/or vibration control can be achieved as done in the motor vehicle factory. When the LASD material is applied, the multi-bead texture has a plurality of beads of the material which are immediately adjacent to each other, and uniformly shaped or routed.

### BRIEF DESCRIPTION OF THE DRAWINGS

The principles and the other aspects of the present disclosure will be explained in the following description with reference to the drawings. In the drawings of the present disclosure, the features having the same configuration or same functions may be represented by the same reference numerals respectively.

FIG. 1 is a perspective view schematically illustrating a nozzle according to an embodiment of the present disclosure.

FIG. 2 is an end view seen from a distal end of the nozzle and schematically illustrating the nozzle of FIG. 1.

FIG. 3 is a plan view schematically illustrating the nozzle.

FIG. 4 is a lateral view schematically illustrating the nozzle.

FIG. 5 is a cross-sectional view obtained along a line A-A of the nozzle of FIG. 3.

FIG. 6 is a perspective section view schematically illustrating one half part of the nozzle subdivided along an imaginary median plane of the nozzle.

FIG. 7 is a perspective section view schematically illustrating the other half part of the nozzle subdivided along the imaginary median plane of the nozzle.

FIG. 8 is a block diagram schematically illustrating an apparatus comprising the nozzle.

FIG. 9 is a photograph showing a multi-bead texture obtained by the nozzle of an embodiment of the present disclosure.

FIG. 10 is a perspective view schematically illustrating a nozzle according to another embodiment of the present disclosure.

FIG. 11 is a perspective view schematically illustrating a nozzle according to another embodiment of the present disclosure.

### DETAILED DESCRIPTION OF EMBODIMENTS

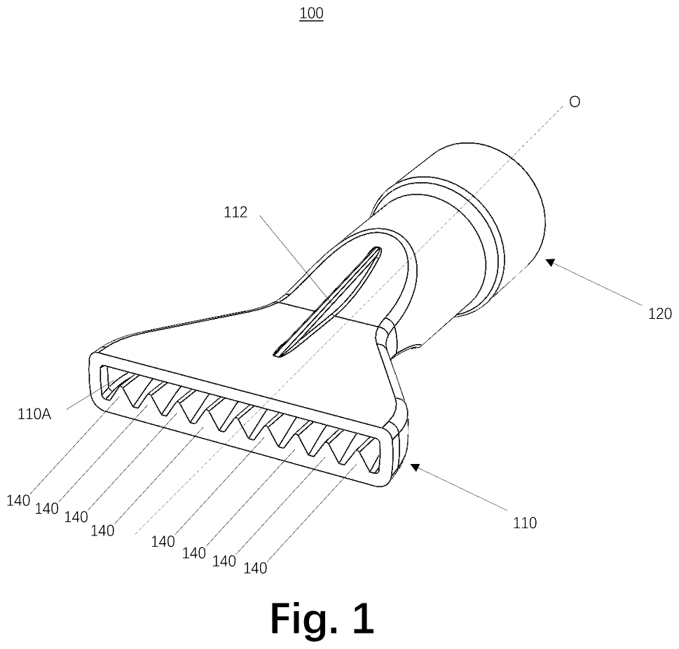

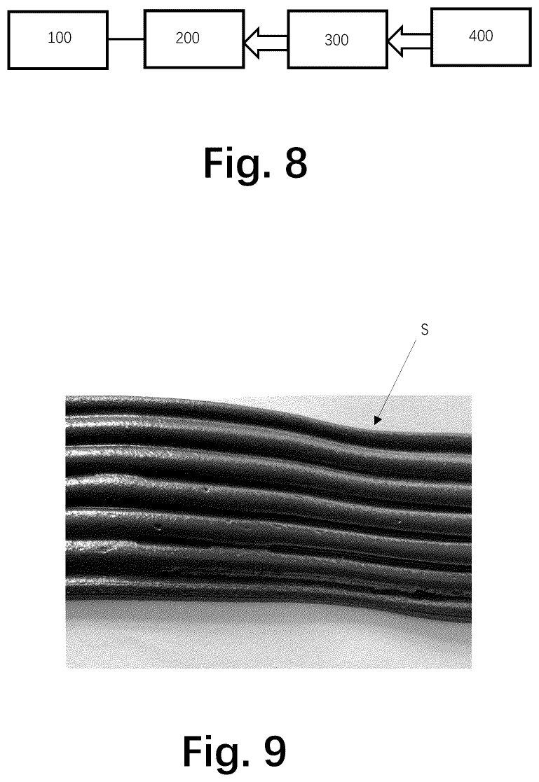

A nozzle 100 according to an embodiment of the present disclosure is generally shown by FIG. 1. The nozzle 100 is integrally formed by a heat-resistant material, such as an engineering plastic material. The nozzle 100 is provided with two opposing ends, i.e., an end 110 and an end 120. In an interior of the nozzle 100, a hollow chamber is defined between the ends 110 and 120. The end 120 of the nozzle 100 is configured to be releasably coupled to an applicator 200, as shown by FIG. 8. For instance, the applicator 200 and the nozzle 100 releasably coupled to the applicator can constitute an applicator assembly. In the context of the present disclosure, the end 120 can be also called as a proximal end. Therefore, the end 110 can be also called a distal end.

FIG. 8 shows an apparatus comprising the applicator 200, a pumping device 300, and a container 400. For example, an applicator 200 can be in the form of a distribution gun (not shown here). The applicator 200 is coupled to the pumping device 300 via a pipeline (not shown here, such as a hose). Therefore, the applicator 200 is configured to be in fluid communication with the pumping device 300. Furthermore, the applicator 200 is provided with a switch (not shown here) by which operation of the pumping device 300 is controllable. The pumping device 300 is also coupled to the container 400 via a pipeline (not shown here, such as a hose). Therefore, the pumping device 300 is configured to be in fluid communication with the container 400. The container 400 is configured to store a flowable viscous material therein. The pumping device 300 is configured to, depending on manual manipulation of the switch, pump the flowable viscous material through the applicator 200 and finally out of the nozzle 100. In an embodiment, a heater (not shown) can be equipped for the apparatus such that the flowable viscous material, during or prior to being pumped, can be heated to a given temperature for a given period. According to the present application, the flowable viscous material comprises a flowable damping sound insulation material suitable for forming a liquid applied sound deadener, or other suitable flowable viscous material such as a flowable sealant, or the like. Therefore, it should be understood that although embodiments of the present application will be explained below by taking the flowable damping sound insulation material for example, the embodiments are also applicable for the other suitable flowable viscous material such as the flowable sealant.

In a preferred embodiment, the nozzle 100 can be used to distribute the flowable damping sound insulation material at room temperature. In this case, the flowable damping sound insulation material can be filled into a cartridge (not shown here). The nozzle 100 can be directly attached to the cartridge (not shown here). The cartridge can be operatively and releasably coupled to an application dispenser, for example a manually operative application dispenser or an electrically operative application dispenser. For instance, the cartridge can be at least partially installed in the application dispenser such that manual manipulation of the application dispenser can enable the flowable damping sound insulation material to be applied or extruded through the nozzle 100. In an embodiment, the applicator 200 can comprise the application dispenser and the cartridge. It is conceived that application pressure and/or extrusion rate can be adjusted manually by the application dispenser.

It should be understood that although the apparatus is shown by FIG. 8, this does not mean that the nozzle 100 and/or the applicator 200 can be used in a production line situation only, as described in the Background part (such as in those manufacturing plants). According to the present disclosure, it is more preferred that the nozzle 100 and/or the applicator 200 and/or the applicator assembly is used to distribute the flowable damping sound insulation material in a non-production line situation only, under a condition of room temperature. It should be understood that in the context of the present disclosure, the term “non-production line situation” may refer to a situation not like those manufacturing plants, especially of motor vehicles. For example, such a non-production line situation can be a motor vehicle's service shop situation or other suitable situations where manual (non-machine) distribution or application of the flowable damping sound insulation material is required.

During usage of the applicator assembly, the nozzle 100 is first coupled to the cartridge which is then coupled to the application dispenser, especially at room temperature in the non-production line situation, such that manual manipulation of the application dispenser will enable the flowable damping sound insulation material to be selectively distributed through the nozzle to a surface to be coated. Depending on different regions of the earth where the nozzle 100 and/or the applicator 200 and/or the applicator assembly will be used, the room temperature can be in a range of 10° C. and 50° C. or even less or more.

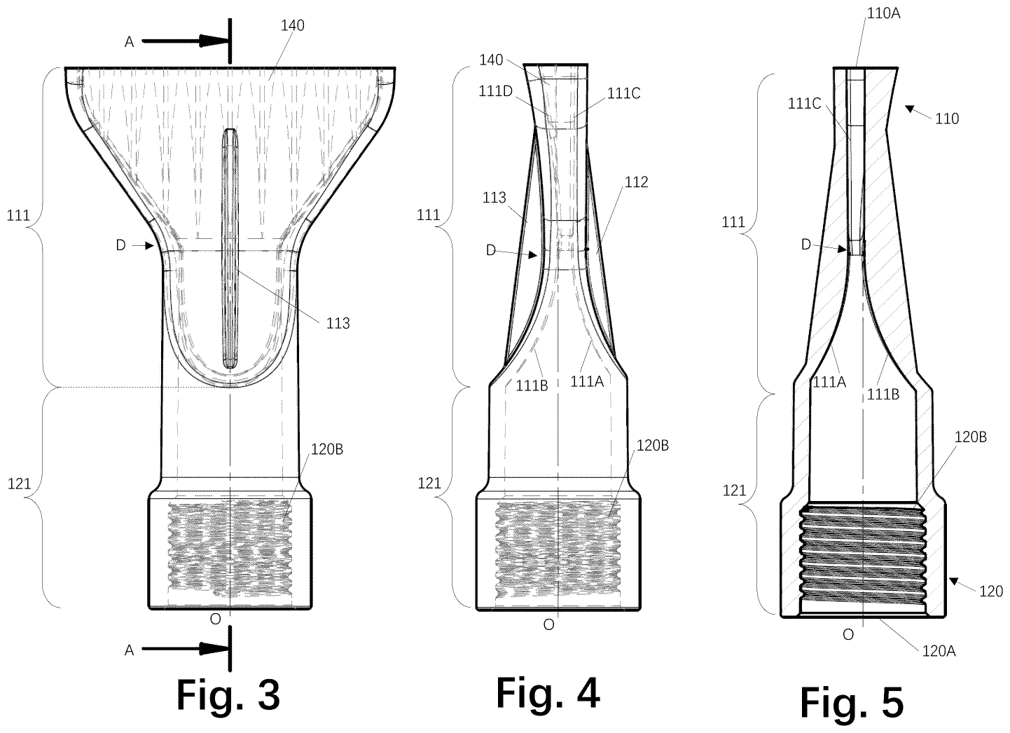

As shown by FIGS. 3 to 5, the proximal end 120 has an end side in which a single opening is formed. For instance, this single opening can be called as a proximal opening 120A. Similarly, the distal end 110 has an end side in which a single opening is formed. For instance, this single opening can be called a distal opening 110A. The distal opening 110A and the proximal opening 120A are in fluid communication with the hollow chamber. The distal opening 110A has a cross-sectional area less than that of the proximal opening 120A. In the context of the present disclosure, a cross-section of the nozzle 100 or the hollow chamber or a feature refers to a section of the nozzle 100 or the hollow chamber or the feature perpendicular to a lengthwise direction of the nozzle 100 or the hollow chamber of the feature. For instance, a longitudinal central axis O is shown in FIGS. 1, 3 to 5, which longitudinal central axis O is parallel to or along the lengthwise direction.

In an embodiment, in order that the proximal end 120 can be releasably coupled to the applicator 200, the proximal end 120 is formed with internal threads 120B in its inner wall and a corresponding port (not shown here) of the applicator 200 is formed with external threads (not shown here) such that they may engage or disengage each other. In an alternative embodiment, it is also possible that the proximal end 120 can be formed with external threads in its outer wall and the corresponding port of the applicator 200 can be formed with respective internal threads.

From the proximal end 120 to the distal end 100, the nozzle 100 can be divided into two segments 121 and 111. The segment 121 can be called as a proximal segment 121, and the segment 111 can be called as a distal segment 111. The proximal end 120 is defined or formed in the proximal segment 121, and the distal end 110 is defined or formed in the distal segment 111. The proximal segment 121 has a substantially cylindrical profile provided with a ring of flange by which the proximal end 120 is defined. As shown, the distal segment 111 is configured to become gradually wider from a location, which is at a distance from the proximal segment 120 and is generally marked by a reference numeral D in FIGS. 3 to 5, to the end side where the distal opening 110A is formed. As shown by FIG. 3, due to the gradual widening of the distal segment 111, the outer profile of the distal segment 111 have two side edges which include with each other by an angle of ∝. The angle ∝ is in a range between 50 degrees and 90 degrees. In a preferred embodiment, the angle of ∝ is 70.9 degrees. As shown by FIG. 4, observed along a thickness direction of the nozzle 100, the distal segment 111 is formed such that it gradually tapers from the proximal segment 120 to the above-mentioned location D, and then gradually expands from the above-mentioned location D to the end side where the distal opening 110A is formed. The distal segment 111 is provided with two opposing reinforcement ribs 112 and 113 on its opposing outer surfaces respectively to increase the structural strength of the nozzle 100 and prevent it from being broken during usage. Observed in the plan view of FIG. 3, each of the reinforcement ribs 112 and 113 is configured to have a length extending along the longitudinal central axis O. Moreover, each of the reinforcement ribs 112 and 113 is configured to stand vertically from the respective surface. It should be noticed that a wall thickness of the distal segment 111 or the profile of the distal segment 111 does not consider the reinforcement ribs 112 and 113. Although only a single reinforcement rib is shown to be formed in the respective surface, two or more similar reinforcement ribs (if necessary) could be formed in the respective surface to achieve an increased structural strength effect.

The hollow chamber defined in the nozzle 100 substantially follows the outer profiles of the proximal and distal segments 121 and 111. That is to say, the hollow chamber is substantially cylindrical in the proximal segment 121 and becomes wider in the distal segment 111 as the hollow chamber in the distal segment 111 extends from the location D to the end side where distal opening 110A is formed. Moreover, observed along the thickness direction of the nozzle 100, the hollow chamber in the distal segment 111 gradually tapers from the proximal segment 121 to the location D. Furthermore, as shown by FIG. 4, from the location D, as mentioned by the previous paragraph, to the end side where the distal opening 110A is formed, the outer surface of the distal segment 111 where the reinforcement rib 112 is formed is configured to be flat and extend substantially parallel to the longitudinal central axis O. However, from the location D, as mentioned by the previous paragraph, to the end side where the distal opening 110A is formed, the outer surface of the distal segment 111 where the reinforcement rib 113 is formed is configured such that as the outer surface extends, the outer surface gradually departs outwards from the longitudinal central axis O. Moreover, as shown by FIG. 4, the outer surface of the proximal segment 121 where the reinforcement rib 112 is formed is also configured to be curved from the proximal segment 121 to the location D as mentioned by the previous paragraph. Similarly, the outer surface of the proximal segment 121 where the reinforcement rib 113 is formed is also configured to be curved from the proximal segment 121 to the location D as mentioned by the previous paragraph. The two outer surfaces are curved such that they protrude inwards or towards each other. The hollow chamber in the distal segment 111 from the proximal segment 121 to the location D has two opposing inner walls 111A, 111B which are shaped like the respective outer surfaces. Such a design of the hollow chamber in the distal segment 111 is advantageous in that when the flowable damping sound insulation material supplied by the applicator 200 is flowing through the hollow chamber, especially from the proximal segment 121 towards the distal segment 111, the flowing material will be pressurized naturally and smoothly by the inwards curved inner walls such that the flowing material may not be unexpectedly blocked at a position substantially corresponding to the location D as mentioned by the previous paragraph. If such a design is not adopted, the unexpected block of the flowing material most likely occurs because the cross-sectional area of the hollow chamber reaches its minimum generally at the position substantially corresponding to the location D as mentioned by the previous paragraph. In an alternative embodiment,

As shown, the hollow chamber in the distal segment 111 from the location D to the end side, where the distal opening 110A is formed, has two opposing inner walls 111C and 111D. The inner wall 111C is configured to be continuous with the inner wall 111A, and the inner wall 111D is configured to be continuous with the inner wall 111B. Unlike the inner walls 111A and 111B as shown, the inner wall 111C is configured to be substantially flat. Different than the inner wall 111C, the inner wall 111D is configured such that as it extends from the location D to the end side where the distal opening 110A is formed, the inner wall 111D departs outwards from the longitudinal central axis O or the inner wall 111C.

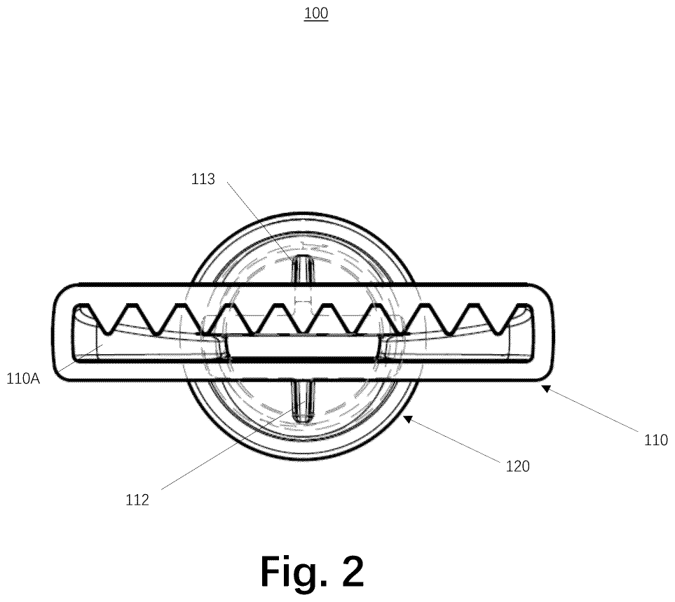

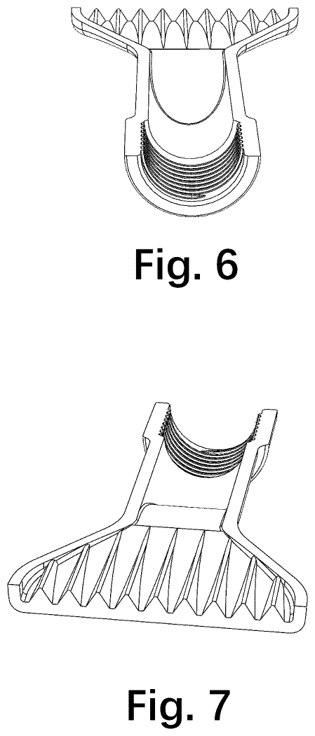

In an embodiment, there are several ridges 140 formed in the inner wall 111D. At least some of the ridges 140 may have different lengths. Moreover, all the ridges 140 are formed such that they protrude from the inner wall 111D towards the inner wall 111C, but leave from the inner wall 111C by an interval. At the end side of the distal end 110, the ridges 140 are flush with each other. The ridges 140 are substantially parallel to each other and to the longitudinal central axis O. Moreover, observed in a widthwise direction of the nozzle 100, the ridges 140 are spaced from each other. Each of the ridges 140 is configured in such a way that as the respective ridge 140 extends from a start point within the hollow chamber to the end side of the distal end 111, the cross-sectional area of the ridge 140 itself becomes gradually greater (as shown by FIGS. 6 and 7) and finally reaches its maximum at the end side. In an embodiment, the cross-section of the ridges 140 is triangle-shaped (as shown by FIG. 2) with the triangle's vertex pointing towards the inner wall 111C. It is conceivable that the vertex can be chamfered. It can be understood that as the respective ridge 140 extends from the start point within the hollow chamber to the end side of the distal end 111, the vertex of the triangle-shaped cross-sectional area of the ridge will form a vertex line. In this case, the vertex lines of the ridges 140 are spaced from each other in the widthwise direction by a first interval. Moreover, the vertex lines of the ridges 140 are spaced from the flat inner wall 111C in the thickness direction by a second interval. In an embodiment, the first interval is greater than the second interval. Each ridge 140 has two slopes which intersect with each other at the vertex line of the ridge 140. Between two adjacent ridges 140, a channel is formed by two slopes of the adjacent ridges 140 facing each other. For the outermost one of all the ridges 140 along the widthwise direction, a channel is formed between a lateral sidewall of the hollow chamber and a slope of the outermost ridge 140 facing the lateral sidewall. Therefore, several channels are formed in the hollow chamber. Due to the existence of the channels, when a flowable damping sound insulation material suitable for forming the LASD is distributed from the nozzle 100 onto a surface to be coated, a flat strip of beads of the material will be left on the surface to be coated. When several flat strips (only one strip S is shown in FIG. 9) are left side-by-side on the surface by the nozzle 100 according to an embodiment of the present disclosure, a multi-bead texture of the material can be applied onto the surface. Unlike the prior art, no scraper is needed to generate a similar multi-bead texture. According to the present disclosure, as the material is distributed out of the nozzle 100, the beads are naturally generated. Therefore, it will be very convenient for a technician of a service shop to apply the flowable damping sound insulation material in a specified multi-bead texture onto a surface of a component of a motor vehicle after he/she has repaired or inspected the component. At least for the technician of the service shop, this will result in higher working efficiency.

Returning to FIG. 2, it may be seen that along the thickness direction of the nozzle 100, the distal opening 110A has two opposing edges, one of which is a straight edge and the other of which is a sawtooth-shaped edge. The straight edge is formed by the inner wall 111C, and the sawtooth-shaped edge is formed by the ridges 140. The two slopes of one ridge 140 include with each other by an angle. This angle and the first interval can be sized depending on the beads of the applied material. For instance, this angle can be in a range between 40 and 80 degrees, and the first interval can be in a range of 2 mm and 10 mm. In a preferred embodiment, this angle can be 64 degrees and the first interval can be 3.9 mm. It is understood that the channel between two adjacent ridges 140 has a width which becomes gradually greater as the channel extends towards the distal opening 110A. According to the present disclosure, the ridges 140 are advantageous in that they can ensure that the beads of the material can be stably and uniformly applied.

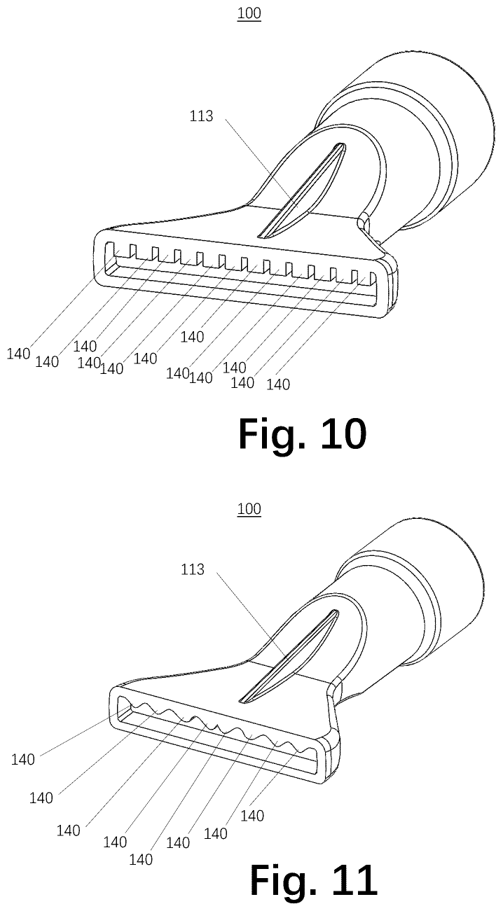

When the nozzle 100 is adopted, it is releasably coupled to the applicator 200 via the proximal end 120. After the switch of the applicator 200 is manipulated, the damping sound insulation material suitable for forming the LASD can be pumped and heated from the container 400 through the applicator 200. Then, the damping sound insulation material can be distributed through the distal opening 110A of the nozzle 100 onto a surface to be coated of a motor vehicle. During the distribution of the material, the straight edge of the distal opening 110A of the nozzle 100 is closer to the surface than the sawtooth-shaped edge of the distal opening 110A. In a multi-bead texture generated by the distribution of the material, beads of the material are exposed and adjacent to each other. The beads are uniformly shaped or routed to generate an increased surface area on which a sound or vibration deadening sheet can be placed. Therefore, the sound or vibration deadening sheet can be securely attached to the surface such that noise and/or vibration control can readily reach the same level as the motor vehicle leaving its manufacturing factory. In alternative embodiments, the sawtooth-shaped edge of the distal opening 110A can be replaced with a sine-shaped or wave-shaped edge, as shown by FIGS. 10 and 11. In this case, the sine-shaped or wave-shaped edge is also defined by the ridges in the distal opening 110A such that as the ridges extend from their respective start points within the hollow chamber to the end side of the distal end, the vertexes of crests of the sine or wave shape of the cross-sectional area of the ridges form vertex lines. It should be noted that the term “sine” can alternatively refer to “cosine”. It should be also noted that the term “wave-shape” or “wave-shaped” can also refer to “rectangular-wave-shape”, “square-wave-shape” or “regular-wave-shaped”, “square-wave-shaped” respectively. In an alternative embodiment, the ridges 140 can have the same or different cross-sections. In an alternative embodiment, the ridges 140 can be shaped differently or identically.

For instance, the damping sound insulation material can be TEROSON® WT 330 T or TEROSON WT 330 V which is available in the market. For instance, the distribution gun can be TEROSON ET POWERLINE II available in the market. In an embodiment, before the distribution of the damping sound insulation material,

Although some specific embodiments and/or examples of the present disclosure are described here, they are given for illustrative purposes only and cannot be deemed to constrain the scope of the present disclosure in any way. Furthermore, it should be understood by a skilled person in the art that the embodiments and/or examples described here can be combined with each other. Without departing from the spirit and scope of the present disclosure, various replacements, modifications, and alternations can be carried out.

1. A nozzle (100) for an applicator (200) which is configured to apply a flowable viscous material, the nozzle (100) comprising:
a proximal end (120) releasably coupled to the applicator (200) and having an end side comprising a single proximal opening (120A);
a distal end (110) opposing the proximal end (120) and having an end side comprising a single distal opening (110A); and
a hollow chamber defined in an interior of the nozzle (100) between the proximal end (120) and the distal end (110) and in fluid communication with both the proximal opening (120A) and the distal opening (110A);
wherein the nozzle (100) is configured such that when being distributed by the nozzle (100), the flowable viscous material can be supplied from the proximal end (120) to the distal end (110A) and discharged out of the distal opening (110A), and the distal opening (110A) has a straight edge and a sawtooth-shaped or sine-shaped or wave-shaped edge opposing the straight edge.

2. The nozzle (100) according to claim 1, wherein the distal opening (110A) has a cross-sectional area less than that of the proximal opening (120A).

3. The nozzle (100) according to claim 1, wherein the nozzle (100) is divided into a proximal segment (121) in which the proximal end (110) is located and a distal segment (111) in which the distal end (120) is located; the hollow chamber is substantially cylindrical in the proximal segment (121) and becomes wider in the distal segment (111) as the hollow chamber in the distal segment (111) extends from a location (D), at a distance from the proximal end (110), to the end side where the distal opening (110A) is located, and where observed along a thickness direction of the nozzle (100), the hollow chamber in the distal segment (111) gradually tapers from the proximal segment (121) to the location (D) and then gradually expands from the location (D) to the end side where the distal opening (110A) is located.

4. The nozzle (100) according to claim 3, wherein the hollow chamber has a cross-sectional area that reaches its minimum substantially at the location (D).

5. The nozzle (100) according to claim 4, wherein the hollow chamber in the distal segment (111) is configured to have two opposing inner walls between the location (D) and the end side where the distal opening (110A) is located.

6. The nozzle (100) according to claim 5, wherein a first inner wall (111C) of the two opposing inner walls is substantially flat; and a second inner wall (111D) of the two opposing inner walls is configured such that as the second inner wall extends from the location (D) to the end side where the distal opening (110A) is located, the second inner wall (111D) departs outwards from the first inner wall (111C).

7. The nozzle (100) according to claim 6, wherein several ridges (140) are formed in the second inner wall (111D) such that the ridges protrude from the second inner wall (111D) towards the first inner wall (111C), but are spaced from the first inner wall (111C).

8. The nozzle (100) according to claim 7, wherein at least some of the ridges (140) have different lengths.

9. The nozzle (100) according to claim 8, wherein the ridges (140) are flush with each other at the end side of the distal end (110) such that the sawtooth-shaped or sine-shaped or wave-shaped edge is defined by the ridges (140) in the distal opening (110A).

10. The nozzle (100) according to claim 9, wherein the ridges (140) are spaced from each other along a widthwise direction of the nozzle (100).

11. The nozzle (100) according to claim 10, wherein each of the ridges (140) is configured such that as the respective ridge (140) extends from a start point within the hollow chamber to the end side of the distal end (111), the cross-sectional area of the ridge (140) itself becomes gradually greater and finally reaches its maximum at the end side of the distal end (111).

12. The nozzle (100) according to claim 11, wherein the cross-section of the ridges (140) is triangle-shaped with the triangle's vertex pointing towards the first inner wall (111C).

13. The nozzle (100) according to claim 12, wherein in case of the sawtooth-shaped edge, as each ridge (140) extends from its start point within the hollow chamber to the end side of the distal end (111), the vertex of the triangle-shaped cross-sectional area of the ridge forms a vertex line.

14. The nozzle (100) according to claim 12, wherein in case of the sine-shaped or wave-shaped edge, as the ridges extend from their respective start points within the hollow chamber to the end side of the distal end, the vertexes of crests of the sine or wave shape of the cross-sectional area of the ridges form vertex lines.

15. The nozzle (100) according to claim 13, wherein vertex lines of the ridges (140) are parallel to each other and spaced from each other in the widthwise direction by a first interval, and are spaced from the first inner wall (111C) in the thickness direction by a second interval less than the first interval.

16. The nozzle (100) according to claim 15, wherein each ridge (140) has two slopes which intersect with each other at the vertex line of the ridge (140).

17. The nozzle (100) according to claim 16, wherein between two adjacent ridges (140), a channel is formed by two slopes of the adjacent ridges (140) facing each other, and/or a channel is formed between a lateral sidewall of the hollow chamber and the outermost ridge of the ridges (140) along the widthwise direction adjacent to the lateral side wall such that several channels are formed in the hollow chamber.

18. The nozzle (100) according to claim 4, wherein the distal segment (111) has two opposing outer surfaces on each of which is formed with a reinforcement rib configured to have a length extending along a longitudinal central axis of the nozzle (100).

19. The nozzle (100) according to claim 1, wherein the flowable viscous material is a flowable damping insulation material or a flowable sealant.

20. The nozzle (100) according to claim 19, wherein the applicator is configured as a hand-held tool or a line machinery operative capable of applying the flowable damping insulation material or the flowable sealant.

21. An applicator assembly capable of applying a flowable viscous material, comprising:
an applicator (200) including a cartridge for containing the flowable viscous material therein and an application dispenser operatively and releasably coupled to the cartridge; and
a nozzle (100) according to claim 1, wherein the nozzle (100) is configured such that it is releasably coupled to the cartridge, and the flowable viscous material can be selectively distributed through the nozzle (100) by manual manipulation of the application dispenser.

22. The applicator assembly according to claim 21, wherein the application dispenser is a manually operative application dispenser.

23. The applicator assembly according to claim 21, wherein the applicator is configured as a hand-held tool capable of applying the flowable viscous material.

24. The applicator assembly according to claim 23, wherein the flowable viscous material is a flowable damping insulation material or a flowable sealant.

25. A method of dispensing a flowable viscous material comprising: forming an applicator assembly according to claim 21, by coupling the nozzle (100) to a cartridge before the cartridge is installed into a hand-held applicator, wherein the cartridge is configured to contain a flowable viscous material therein; and coupling the cartridge to the hand-held applicator such that manual manipulation of the application dispenser of the applicator assembly enables the flowable viscous material to be selectively distributed through the nozzle to a surface to be coated at room temperature.

26. The method according to claim 25, wherein during the distribution of the flowable viscous material, letting a sawtooth-shaped or sine-shaped or wave-shaped edge of a distal opening (110A) of the nozzle (100) be closer to a surface to be coated than a straight edge of the distal opening (110A).

27. The method according to claim 25, wherein pressure and/or quantity of the flowable viscous material distributed through the nozzle is adjustable by the applicator.

28. The method according to claim 27, wherein the flowable viscous material is a flowable damping insulation material or a flowable sealant.
